(19) United States
(12) Patent Application Publication
(10) Pub. No.: US 2009/0173116 A1
(43) Pub. Date: Jul. 9, 2009

(54) Locking Mechanism

(75) Inventor: Michael McGuire, Ottawa (CA)

Correspondence Address: SEAN LIAM KELLEHER;Kelleher IP PLLC, 16 PECKSLIP RD, CARMEL, NY, 10512, US

(73) Assignee: T.A.G. ORAL HEALTH TECHNOLOGIES, Saskatchewan (CA)

(21) Appl. No.: 12/203,144

(22) Filed: Sep. 3, 2008

Related U.S. Application Data
(60) Provisional application No. 60/969,690, filed on Sep. 3, 2007.

(51) Int. Cl. E05B 13/10

(52) U.S. Cl. 70/224

(57) ABSTRACT

The present invention provides a locking mechanism positioned in a toothbrush handle having interchangeable heads, comprising a shaft that extends the length of the handle, with an elliptical tip at one end and receiving means at the opposite end. A key may be interconnected to the receiving means to permit the elliptical tip to rotate. In a first position, the elliptical tip permits the removal and replacement of an interchangeable head, because the longer dimensions of the elliptical tip and an elliptically cross-sectioned opening in the interchangeable head coincide. In a second, rotated position, the elliptical tip locks within the interchangeable head, as the longer dimensions no longer coincide.

### FIELD OF THE INVENTION

The present invention relates generally to locking mechanisms and more specifically to a locking mechanism positioned inside a toothbrush handle having interchangeable heads.

### BACKGROUND OF THE INVENTION

The present invention relates to the art of dental instruments. It finds more particular application in a disposable toothbrush where one would only have to dispose, replace, or interchange the top (brush) portion of the toothbrush.

Traditionally, there have been many varieties of toothbrushes which had disposable and interchangeable heads or disposable bristle sections. The reason for wanting disposable heads or brush sections would be either because the handle or gripping section was made from an expensive material, the handle or gripping portion had an ornamental design, or the top section had multiple instrumentalities or replacements. For example, the top section can have different nylon bristle stiffness replacements or interchangeable picking devices and brushes.

These previous toothbrushes have been hard to operate because their connection devices required a lot of strength or coordination to operate. There have been a plurality of connection or attachment devices to connect the top and bottom portions together. For example, there are male/female devices, which are inserted into each other, threaded devices, which screw together, sliding devices, which slide and lock together, similar to the male/female devices, and others known to those skilled in the art.

While certain connecting devices for connecting the top and bottom portions of a disposable toothbrush have been designed in an effort to overcome the foregoing deficiencies, they have not been successful. The problem with the prior art devices is that a person wants to be able to easily and securely attach and detach the top portion of the dental instrument from the bottom portion. With the screw type devices, this was difficult. It took a lot of effort and was difficult for some people with physical challenges to accomplish, making the replacement or interchangeability irrelevant. In the male/female devices, they were often times not secure enough to withstand the forces exerted on the connection during brushing, causing them to become loose. In contrast, other styles of male/female connectors were secured so tightly that they were very difficult to pull apart to replace or interchange the top portion. Further, when the top portion had the male section, there was too much force on the male section and it would sometimes break off.

The daily use suggestions for toothbrushes generally causes sufficient bristle wear that brush overuse is a fairly common problem. This is not only due to the normal reluctance and inconvenience of purchasing and replacing a toothbrush, but also because most users simply cannot determine themselves when the brush itself has become too worn. On the other hand, users have become accustomed to handles with replaceable tool heads for personal and oral hygiene such as razor blades, water picks and the like, so the prospect of having readily replaceable heads for a toothbrush is particularly convenient as an incentive to regularly change the brush head over time for better quality brushing.

Regular toothbrushes are commonly comprised of a handle having a bristle holder at one end, and bundles of bristles installed in the bristle holder. This structure of toothbrush is inconvenient for use by an adult to clean the teeth of a baby or young child. In order to clean the back teeth in a child's mouth it needs to be opened widely so that the bristles of the toothbrush can reach the back teeth. The requirement to have the child's mouth open widely is uncomfortable at best for an adult and for a child as well.

In addition to the different needs of different users, a single user may have relatively large interdental spaces at one place and relatively small interspaces at another place. Thus, it is desirable to provide an interdental brush with a handle that can interchangeably receive and carry different types of brushes.

An example of a interdental toothbrush with a detachable brush is described in U.S. Pat. No. 5,201,091 (Tarrson et al.). The handle has a hinged two-part locking retainer on the end of an elongated handle. The first part of the hinged locking retainer is integral with the handle and the second part is arranged to be folded back and retained adjacent to the first part. The locking retainer has a through hole located in the second part close to the hinge-axis and being arranged to receive the twisted wire forming the stem of the twisted wire brush. When the user is about to use the brush, the stem of the brush is inserted in the through hole and the portion of the stem extending past the hole is received in a slot in said first part of the retainer. Thereafter the second part of the retainer is folded back, thereby bending the stem of the brush. The bending of the stem of the brush prevents the brush from being retracted or further inserted when the interdental brush is used.

However, the bending of the stem is permanent and the brush can only be attached to the handle once. Thus, the user cannot use this type of interdental brush if there is a need for more than one size or shape of the brush.

Furthermore, it is difficult to place and hold the twisted wire stem of the brush in the correct position, before and while folding back the second part of the hinged locking retainer. This drawback is present even for young people with good eyesight and well functioning fingers, and is further pronounced since it is especially elderly people that need interdental brushes. The elderly people may have stiff or weak hands, impaired eyesight or other handicaps that limit their ability to manipulate the handle and the brush.

Another example of a interdental toothbrush with a detachable brush is described in U.S. Pat. No. 5,758,382 (Maekawa et al.). The handle has a hinged two-part locking retainer on the end of an elongated handle. The first part of the hinged locking retainer are integral with the handle and the second part is arranged to be folded back and retained adjacent the first part. The first part has two sidewalls arranged to extend on both sides of the second part in the folded position of the locking retainer. One of the sidewalls has a V-shaped gap for receiving the twisted wire stem of the brush. As the locking retainer is closed, the twisted wire stem is frictionally captured and clamped between the first and second part of the hinged locking retainer. Thus, it is the friction that retains the brush in the handle when the interdental brush is used. In order for the friction to be high enough, the locking retainer must exert a clamping force of high magnitude, which in turn implies that the locking retainer must be rigid and therefore also relatively large. The high magnitude of the clamping force also implies that the force needed to close the locking retainer is of considerable magnitude, which may be a problem, especially for older people.

Accordingly, there remains a need for improved locking mechanism positioned inside a handle which can effectively lock members together. There is a further need for locking mechanism that reduces the tendency for false locking conditions and increases parental control against the mechanism being unlocked accidentally by the child.

### SUMMARY OF THE INVENTION

It is an object of the present invention to provide a locking mechanism positioned in a toothbrush handle having interchangeable heads, comprising a shaft that extends the length of the handle, with an elliptical tip at one end and receiving means at the opposite end. A key may be interconnected to the receiving means to permit the elliptical tip to rotate. In a first position, the elliptical tip permits the removal and replacement of an interchangeable head, because the longer dimensions of the elliptical tip and an elliptically cross-sectioned opening in the interchangeable head coincide. In a second, rotated position, the elliptical tip locks within the interchangeable head, as the longer dimensions no longer coincide.

### BRIEF DESCRIPTION OF THE DRAWINGS

It will now be convenient to describe the invention with particular reference to one embodiment of the present invention. It will be appreciated that the drawings relate to one embodiment of the present invention only and are not to be taken as limiting the invention.

FIG. 1 is a perspective view of the disassembled locking mechanism to be incorporated within a handle according to one embodiment of the present invention.

FIG. 2 is a perspective view of a handle that incorporates the locking mechanism, with attached interchangeable head, according to one embodiment of the present invention.

FIG. 3 is a perspective view of a handle that incorporates the locking mechanism, without the interchangeable head, according to one embodiment of the present invention.

FIG. 4 is a top view of the locking mechanism in a locked position according to one embodiment of the present invention.

FIG. 5 is a top view of the locking mechanism in an unlocked position according to one embodiment of the present invention.

FIG. 6 is a cut-away side view of the locking mechanism in an unlocked position according to one embodiment of the present invention.

FIG. 7 is a perspective view of the tip of the locking mechanism in an unlocked position within the interchangeable head according to one embodiment of the present invention.

FIG. 8 is a cut-away side view of the locking mechanism in a locked position according to one embodiment of the present invention.

FIG. 9 is a perspective view of the tip of the locking mechanism in a locked position within the interchangeable head according to one embodiment of the present invention

FIG. 10 is a perspective view of a plug positioned in a body panel of a handle according to one embodiment of the present invention.

FIG. 11 is a perspective view of a shaft, plug and key of the locking mechanism according to one embodiment of the present invention.

FIG. 12 is a perspective view of a shaft and a plug of the locking mechanism positioned in a body panel according to one embodiment of the present invention.

### DETAILED DESCRIPTION OF THE DRAWINGS

In accordance with one embodiment of the present invention and with reference to FIG. 1, a shaft 10 of the locking mechanism is shown having an elliptical tip 20 at one end and receiving means 30 at the opposite end. The shaft 10 also has a first cam 40 and a second cam 50 to facilitate the positioning of the shaft 10 within a handle 60 (not shown) having body panels 62 and 64.

With further reference to FIG. 1, the locking mechanism of the present invention has a plug 70 having flanges 80 for interconnecting with the receiving means 30. The key 90 of the locking mechanism of the present invention according to one embodiment has a tongue 95 for insertion into the plug 70 and receiving means 30 of the shaft 10. The body panels 62 and 64 are symmetrical to one another for ease of assembly.

With further reference to FIG. 1, the body panel 64 has protrusions 100 for interconnecting with body panel 62. Body panel 64 has a first receiving means 110 to secure cam 40 from shaft 10 once installed in body panel 64. Body panel 64 also has a second receiving means 120 for cam 50 from shaft 10 once installed in body panel 64. A third receiving means 125 enables the shaft 10 to be positioned in the body panel 64 without the use of a cam. Body panel 62 has symmetrical receiving means as found on body panel 64 and a worker skilled in the relevant art would be familiar with such symmetrical receiving means in order to allow for the proper installation of the locking mechanism of the present invention within a handle.

With further reference to FIG. 1, the interchangeable head 130, which has an elliptical opening 140 (not shown) on its underside, can be positioned on the elliptical tip 20 of the locking mechanism according to one embodiment of the present invention. When locked on to the elliptical tip 20, the elliptical opening 140 (not shown) overlaps the handle 60 top, which is also elliptical in cross-section. Once on, the interchangeable tip 130 is prevented from rotating due to this elliptically cross-sectional overlap. The interchangeable head 130 is used for cleaning teeth, and may contain a variety of features in this regard, well-known to one skilled in the art but not detailed here.

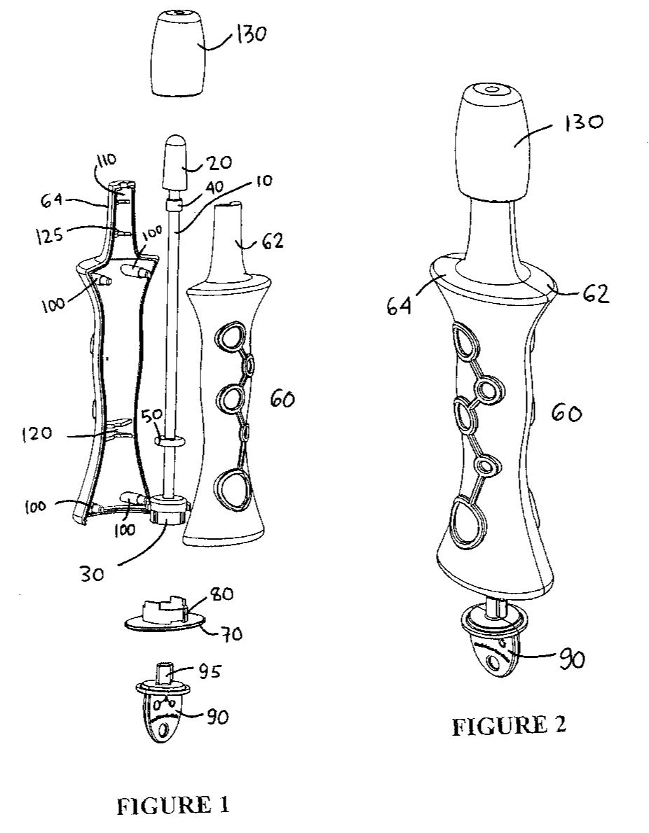

With reference to FIG. 2 and according to one embodiment of the present invention, the handle 60 is shown with body panels 62 and 64 assembled and containing the locking mechanism of the present invention. The interchangeable head 130 is positioned on the elliptical tip 20 (not shown) of the shaft 10 (not shown). The key 90 of the locking mechanism is shown at the bottom of handle 60.

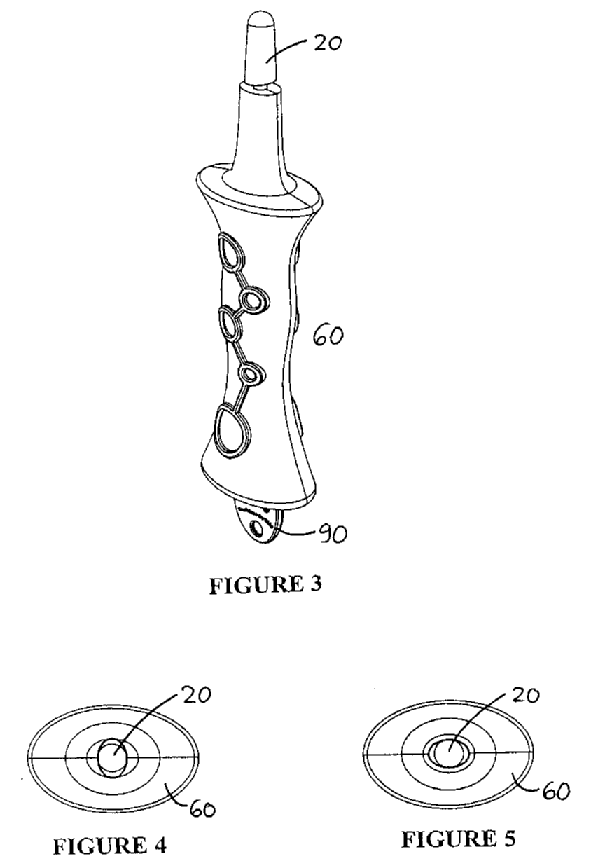

With reference to FIG. 3 and according to one embodiment of the present invention, handle 60 and the elliptical tip 20 are shown with interchangeable head 130 (not shown) removed. The key 90 of the locking mechanism is shown at the bottom of handle 60.

With reference to FIG. 4 and according to one embodiment of the present invention, the elliptical tip 20 is positioned in a locked position wherein the base of tip 20 is perpendicular to the large width of handle 60.

With reference to FIG. 5 and according to one embodiment of the present invention, the elliptical tip 20 is positioned in an unlocked position wherein the base of tip 20 is parallel to the larger width of handle 60.

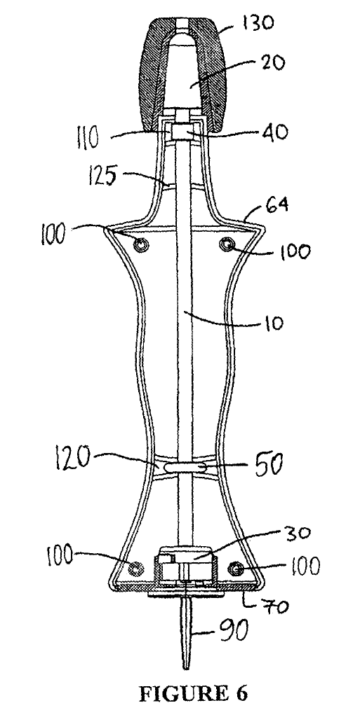

With reference to the cut-away view shown in FIG. 6 and according to one embodiment of the present invention, the locking mechanism is positioned within the body panel 62. The first cam 40 of the shaft 10 is positioned within the receiving means 110. The second cam 50 is positioned within the second receiving means 120. The shaft 10 is positioned in receiving means 125. The use of these receiving means allows for the shaft 10 to be centralized within body panel 62, and rotate freely within the handle 60 (not shown). Protrusions 100 extend from body panel 62 to receive second body panel 64 (not shown) and hold it in place. This method of assembly is well-known to one skilled in the art, and he or she would know that assembly may be accomplished by various other means as well.

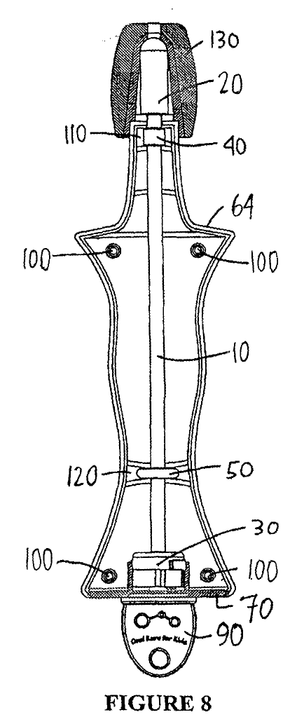

With further reference to FIG. 6, the key 90 of the locking mechanism of the present invention according to one embodiment of the present invention is interconnected with the plug 70 and receiving means 30. The elliptical tip 20 of the shaft 10 is positioned in an unlocked position relative to the interchangeable head 130, meaning that the interchangeable head 130 may be removed from the elliptical tip 20. The locking mechanism is locked by turning the key 90 ninety degrees from its unlocked position, as shown in FIG. 8. In other embodiments, the key 90 may be a simple as a screwdriver or coin, or more complex, in order to prevent the interchangeable head 130 from separating from the handle 60 while in the mouth of a child, for example.

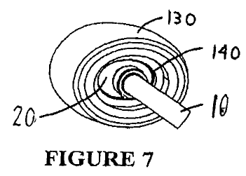

With reference to FIG. 7 and according to one embodiment of the present invention, the elliptical tip 20 of the shaft 10 is positioned within an interchangeable head 130 in an unlocked position. The elliptical tip 20 is inserted into the interchangeable head 130 through opening 140. The interchangeable head 130 is elliptical in cross-section and has flexible properties as would be known by a worker skilled in the relevant art allowing for the elliptical tip 20 to be inserted within the interchangeable head 130. In order to insert the elliptical tip 20 into the interchangeable head 130, the longer dimensions of the elliptical tip 20 and opening 140 coincide. The top of the handle has an elliptical cross-section, and the opening 140 of the interchangeable head 130, which is elliptical in cross-section, fits over the top of the handle such that the interchangeable head 130 cannot rotate independently of the handle 60. The opening 140 contains a lip (not shown) within its opening, such that when the elliptical tip 20 is rotated ninety degrees to a locked position, the elliptical tip 20 is locked within the opening 140 and cannot pass out of the opening, because the longer dimensions of the ellipses do not coincide.

With reference to FIG. 8 and according to one embodiment of the present invention, the locking mechanism is positioned within the body panel 64. The elliptical tip 20 is shown in a locked position within interchangeable head 130 which prevents the insertion or removal of the elliptical tip 20 or from the head 130. The key 90 of the locking mechanism is interconnected with the plug 70 and receiving means 30.

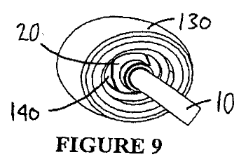

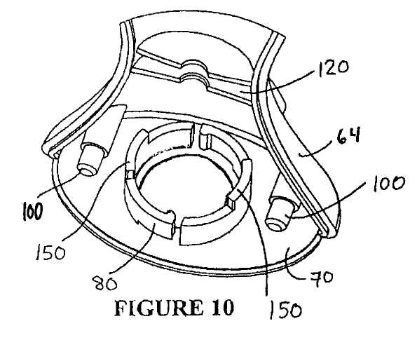

With reference to FIG. 9 and according to one embodiment of the present invention, the elliptical tip 20 of the shaft 10 is positioned within the opening 140 in a locked position. The opening 140 is elliptical in cross-section, and opens up to a cylindrical chamber (not shown) within the interchangeable head 130, which chamber is the length of the elliptical tip 20 with a diameter equal to the longer dimension of the cross-section of the elliptical tip 20. As a result of this configuration, two ledges (not shown) necessarily appear within the interchangeable head, at the junction between the opening 140 and cylindrical chamber (not shown), where the cylindrical chamber (not shown) opens from the elliptically cross-sectional opening. It is on these two ledges that the base of the elliptical tip rests when in a rotated (locked) position, which prevents the interchangeable head 130 from being removed from the elliptical tip 20 and handle 60. When in a locked position, the longer dimension of elliptical tip 20 is perpendicular to the longer dimension of elliptical cross-sectioned opening 140 which allows for the interchangeable head 130 to be locked onto the elliptical tip 20.

With reference to FIG. 10 and according to one embodiment of the present invention, body panel 64 and plug 70 are shown interconnected. A worker skilled in the relevant art would be familiar with various methods available to interconnect such members, including the use of glue or tabs. Receiving means 120 are also shown in body panel 64 to receive cam 50 (not shown). Protrusions 100 are also shown at the bottom of body panel 64 for interconnection with body panel 62 (not shown). Flanges 80 extend away from plug 70 for interconnection with receiving means 30 (not shown). Stop means 150 are positioned on flanges 80 in order to control the movement of shaft 10 (not shown) from an unlocked to locked position. Stop means 150 consist of precisely positioned flange extensions on flanges 80.

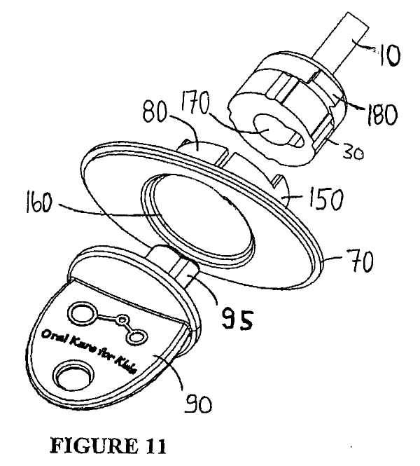

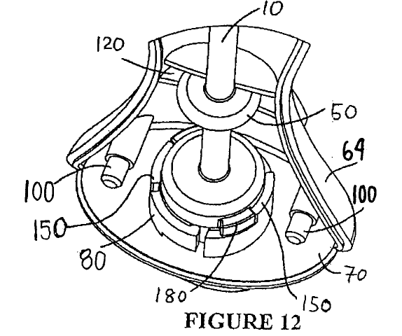

With reference to FIG. 11 and according to one embodiment of the present invention, the shaft 10, plug 70 and key 90 are shown in alignment for interconnection with one another. The receiving means 30 of the shaft 10 interconnects with flanges 80 of the plug 70 and the key 90 interconnects with the plug 70 through tongue 95 and plug opening 160. Tongue 95 also interconnect with keyhole 170 in receiving means 30 which allows for the movement of the shaft 10 from an unlocked to locked position. Control means 180 on receiving means 30 interact with stop means 150 on flanges 80 to limit the movement of shaft 10 between unlocked to locked positions.

With reference to FIG. 12 and according to one embodiment of the present invention, body panel 64, shaft 10 and plug 70 are interconnected with one another. The shaft 10 is positioned within the body panel 62 through cam 50 located in receiving means 120. The plug 70 is fixed to body panel 64 through a clip mechanism, for example, or other means of attachment as would be known by a worker skilled in the relevant art. Protrusions 100 are shown and enabled the interconnection of body panel 64 with body panel 62 (not shown). Stop means 150 interact with control means 180 permitting the shaft 10 to move between unlocked and locked positions.

It is to be understood that the above detailed description of one embodiment of the present invention is provided as an example only. Various details of the design may be modified without departing from the true spirit and scope of the invention.

The embodiment of the invention in which an exclusive property or privilege is claimed are defined as follows:

1. A locking mechanism, contained within a handle comprising:
i) A shaft with an elliptical tip at one end and receiving means at the opposite end;
ii) A key that interconnects with the receiving means of the shaft, permitting the elliptical tip of the shaft to rotate; and
iii) interchangeable heads that interconnect with the elliptical tip of the shaft wherein the interchangeable heads are locked to the handle by means of rotation of the elliptical tip.

2. A locking mechanism according to claim 1, wherein the shaft has one or more cams.

3. A locking mechanism according to claim 1, wherein the receiving means is a key opening to receive the key.

4. A locking mechanism according to claim 1, wherein the handle is comprised of two body panels.

5. A locking mechanism according to claim 1, wherein the handle has a plug positioned within the base of the handle.

6. A locking mechanism according to claim 1, wherein the plug has stop means to limit the movement of the shaft within a locked and unlocked position.

7. A locking mechanism according to claim 1, wherein the stop means are flange extensions.
